(19) United States
(12) Patent Application Publication
(10) Pub. No.: US 2012/0329937 A1
(43) Pub. Date: Dec. 27, 2012

(54) PRECIPITATED SILICA

(75) Inventor: Rémi Valero, Tassin Le Demi Lune (FR)

(73) Assignee: BLUESTAR SILICONES FRANCE, Saint Fons (FR)

(21) Appl. No.: 13/518,856

(22) PCT Filed: Dec. 20, 2010
(86) PCT No.: PCT/EP2010/070204

§ 371 Date: Sep. 12, 2012

(30) Foreign Application Priority Data
Dec. 23, 2009 (FR) 09 06317

(51) Int. Cl. C01B 33/12; C08L 83/04; C08K 3/36

(52) U.S. Cl. 524/493; 423/339; 428/402; 524/500

(57) ABSTRACT

The present invention relates to a method for preparing precipitated silica, in particular in powder form. The invention also relates to the resulting precipitated silicas and to the use thereof, in particular for the reinforcement of silicone elastomer or silicone paste matrices.

The present invention relates to a method for preparing precipitated silica, notably in the form of powder. The invention also relates to the resultant precipitated silicas, and use thereof, notably for reinforcing silicone elastomer matrices or matrices based on silicone pastes.

Pyrogenic silicas, i.e. silicas obtained by a method consisting of high-temperature reaction of compounds of the tetrachlorosilane type with hydrogen and oxygen, have long been used as reinforcing fillers in compositions of the silicone elastomer or silicone paste type.

However, because of the way they are obtained, pyrogenic silicas are generally expensive. Accordingly, in applications for reinforcement of silicone matrices, efforts were soon made to replace, at least partially, these high-priced silicas with so-called “precipitated” silicas, obtained by precipitating a silica in an aqueous medium starting from a precursor such as a silicate, in appropriate conditions of pH. In fact, these silicas are less expensive and they can have the required characteristics of dispersibility in a silicone-based matrix.

For many years, therefore, efforts have been made to replace, at least partially, these pyrogenic silicas with lower-priced precipitated silicas. There are various methods for preparing precipitated silicas, said methods being complex and involving control of the temperature, concentrations of reactants, and pH during preparation, as described in French patent 1 352 354.

However, most often, precipitated silicas display strong affinity for water. It is therefore found that precipitated silicas often do not have good properties of reinforcement of silicone matrices, as their compatibility with the silicone matrices in which they are incorporated is not always satisfactory. Thus, patent FR 2 611 196 describes a thermal treatment at high temperature (minimum 700° C.) which is used for preparing precipitated silicas with low water absorption, but these treatments are still expensive in terms of energy and are complex to apply owing to the high temperatures employed.

More recently, patent EP 1 860 066 describes a method for the manufacture of precipitated silica that is particularly interesting for reinforcement of silicone matrices, comprising a step of thermal treatment at high temperature (300-800° C.) in a fluidized bed. However, this step is expensive in terms of energy and requires substantial industrial investment.

There have also been attempts to improve the characteristics of precipitated silicas as reinforcing agent for silicone applications, by making the silicas hydrophobic using a suitable surface treatment (for example using silane or silazane). Hydrophilic silicas made hydrophobic by said treatment and usable for silicone applications are described for example in French patent 2 356 596. However, these treatments also make the processes relatively expensive.

Thus, an essential aim of the present invention is to provide a method for preparing precipitated silica which is simple to apply, does not require large additional industrial investments or high energy expenditure relative to the known methods, and makes it possible to obtain precipitated silicas that are dispersible and that can be used as fillers, notably reinforcing fillers, in silicone-based matrices and can endow them with good mechanical properties.

More specifically, another aim of the invention is to provide precipitated silicas that are dispersible and can be used as fillers, notably reinforcing fillers, in silicone-based matrices, and can endow them with good mechanical properties.

Another aim of the invention is to provide a silicone elastomer precursor organopolysiloxane composition comprising said dispersible precipitated silica.

Another aim of the present invention is to obtain a silicone elastomer comprising said dispersible precipitated silica.

A final aim of the invention is to use the resultant precipitated silica in tires, toothpastes, cosmetic compositions, foodstuff compositions, pharmaceutical compositions, silicone compositions and elastomers.

All these aims, among others, are achieved by the present invention, which relates to a method for preparing a precipitated silica X that is dispersible and has improved reinforcing properties comprising the following steps:

a) reacting at least one silicate with at least one acidifying agent, so as to obtain a suspension A of precipitated silica,

b) filtering and washing said suspension A of precipitated silica, so as to obtain a filter cake B,

c) drying the filter cake B to obtain powder of precipitated silica C, and

d) grinding and drying the precipitated silica C, these two operations being carried out simultaneously in a mechanical grinding mill Z at a temperature between 50 and 190° C., preferably between 60 and 150° C. and even more preferably between 65 and 130° C., and recovering the precipitated silica X.

“Mechanical grinding mill” means an apparatus in which reduction of the particles takes place by mechanical means (for example a jaw crusher, hammer mill or knife mill). This term does not include fluid-jet grinding mills such as air-jet grinding mills, where the particles are entrained by an air jet into a vessel designed in such a way that the particles are subjected to a large number of impacts therein.

One of the advantages of mechanical grinding mills is that the temperature at which grinding takes place has only a very slight effect on the particle size obtained, in contrast to fluid-jet grinding mills where the temperature of the fluid affects its flow rate and consequently the performance of the grinding mill.

To achieve this aim, the inventors were able to demonstrate, surprisingly and unexpectedly, that a precipitated silica having characteristics of dispersibility, a density and a moisture level particularly suitable for use thereof for reinforcing silicone-based matrices, can be obtained by a method of precipitation of silica with execution of the step of grinding and drying simultaneously in a mechanical grinding mill.

Steps a), b) and c) of the method according to the invention are well described in the prior art and are known by a person skilled in the art. In general, the precipitated silica is prepared by a reaction of precipitation of a silicate, such as an alkali metal silicate (sodium silicate for example) with an acidifying agent (sulfuric acid for example). The silica can be precipitated (step a)) by any method: notably, by adding acidifying agent to a sediment of silicate or by simultaneous complete or partial addition of acidifying agent and of silicate to a sediment of water or of silicate. At the end of these operations, a silica pulp is obtained, which is then separated (liquid-solid separation). Said separation generally consists of filtration, which can be carried out according to any suitable method, for example filter-press or band filter or rotary vacuum filter, said filtration resulting in a “filter cake”. The filter cake obtained is submitted to one or more washing operations, generally with water, so as to reduce its salts content (step b)). Optionally, it can also undergo an operation of disintegration prior to the drying step. Drying of the filter cake (step c)) is preferably carried out by spray-drying. For this purpose, any suitable type of atomizer can be used, notably turbine atomizers, nozzle atomizers, liquid-pressure or two-fluid atomizers. In general, the precipitated silica thus separated, filtered, optionally washed and dried can be submitted to further grinding so as to obtain the desired particle size. Various types of grinder can be used, for example air-jet grinding mills or mechanical grinding mills.

In silica manufacturing processes, drying is preferably carried out prior to grinding. In fact, during grinding the density of the precipitated silica will decrease considerably and consequently the volumes of powder to be dried and transported increase considerably. Moreover, handling of powders of fine granulometry must meet stringent requirements on hygiene, safety and environment. Consequently it is in the interests of any industrial concern to proceed to the grinding step as late as possible in the process for manufacture of a precipitated silica.

According to a preferred embodiment, one way of carrying out grinding and drying simultaneously is to control, in step d), the temperature in the mechanical grinding mill Z by supplying air heated to a temperature between 50 and 190° C., preferably between 60 and 150° C. and even more preferably between 65 and 130° C. The temperature can also be controlled by supplying a heated inert fluid (for example nitrogen or argon), but this variant leads to higher operating costs.

According to an even more preferred embodiment, the grinding in step d) is carried out by means of a mechanical grinding mill Z by attrition and more particularly by means of a mechanical grinding mill Z by attrition in a grinding chamber equipped with a rotor and a stator.

In a mill for mechanical grinding by attrition, grinding of the particles takes place between the rotor and the stator. Fragmentation of the particles depends on the probability of impact between the grinding media and the particles. Thus, one and the same particle may be ground several times whereas others are not ground at all. The product obtained consequently has a wide granulometric distribution. To obtain a product with better control of particle size, increase the energy efficiency and avoid overgrinding, mechanical grinding mills can be equipped with air classifiers.

According to a preferred variant of the invention, in step d) the mechanical grinding mill Z is equipped with an integrated particle classifier for recovering the particles of precipitated silica X.

According to another preferred variant of the invention, in step d) the mechanical grinding mill Z is linked to an independent particle classifier for recovering the particles of precipitated silica X.

Without wishing to be bound in any way to a particular theory, it seems possible that carrying out grinding and drying simultaneously can provide immediate drying of the fine particles resulting from grinding, which will thus have less tendency to agglomerate again subsequently and will display better dispersibility.

According to another embodiment of the invention, step d) takes place under atmospheric pressure.

Precipitated silicas are commonly characterized according to the methods and measurements described in detail below:
The BET specific surface, which is measured by the BRUNAUER-EMMET-TELLER method described in The Journal of the American Chemical Society, Vol. 60, page 309 (February 1938).
The CTAB specific surface, determined according to standard NFT 45007 (November 1987).
The pH, measured according to standard ISO 787/9 (pH of a 5% suspension in water).
The moisture level (or residual water content) determined from the weight loss measured after heat treatment at 105° C. for 2 hours (in wt. %).
The tap density or compacted bulk density (densité de remplissage à l'état tassé, DRT) is determined according to standard NF T 30-042.

Furthermore, precipitated silicas generally contain, at least at trace levels, a salt resulting from the action of the acidifying agents employed on the silicates used. Thus, when the method of the invention specifically employs an alkaline silicate as silica precursor and sulfuric acid as acidifying agent, the precipitated silicas contain an alkaline sulfate. Generally, the content of alkaline sulfate in the resultant silicas is relatively low, most often such that the mass of the sulfate ions present generally represents at most 1 wt. % relative to the total mass of dry matter. Controlling the content of sulfates in precipitated silica is important for certain applications. For example, levels of sulfate in precipitated silica above 0.7 wt. % lead to coloration (yellowing) of elastomers containing said silica. Furthermore, it is also known that a high sulfate level promotes appreciable water absorption, so it is beneficial to keep the level of sulfates as low as possible.

According to a preferred embodiment of the invention, in step c) the precipitated silica C has the following characteristics:
a BET surface area between 50 and 300 m²/g,
a CTAB surface area between 50 and 300 m²/g,
the value BET-CTAB<50 m²/g,
moisture level between 4 and 10 wt. %,
a pH between 4 and 8,
a level of sulfates SO₄⁻<1.2 wt. %, and
tap density>100 g/1

According to a more preferred embodiment of the invention, in step c) the precipitated silica C has the following characteristics:
a BET surface area between 130 and 250 m²/g,
a CTAB surface area between 130 and 250 m²/g,
the value BET-CTAB<30 m²/g,
moisture level between 4 and 9 wt. %,
a pH between 4.5 and 7.5,
a level of sulfates SO₄⁻<0.7 wt. %, and
tap density>150 g/1

According to an even more preferred embodiment of the invention, in step c) the precipitated silica C has the following characteristics:
a BET surface area between 155 and 185 m²/g,
a CTAB surface area between 155 and 185 m²/g,
the value BET-CTAB<15 m²/g,
moisture level between 4 and 8 wt. %,
a pH between 5 and 6.5,
a level of sulfates SO₄⁻<0.5 wt. %, and
tap density>200 g/1

Preferably, the precipitated silica C is a dispersible silica such as the silica Z160® marketed by Rhodia, the silica Ultrasil® marketed by Degussa or the silica DRX190® marketed by PPG.

It is important to note that some of the characteristics of precipitated silica C are not altered during step d) of the method with simultaneous grinding-drying. This applies for example to CTAB, BET, pH and the level of sulfates. However, step d) of the method according to the invention enables us to improve the properties of precipitated silica C by lowering its moisture level, reducing its particle size and lowering its tap density.

The invention further relates to precipitated silica X obtainable by the method of the invention, which has the following characteristics:
average particle size Dᵥ50≦20 μm,
moisture level 5 wt. %, and
tap density≦100 g/1

The particle size of precipitated silica is measured with a laser granulometer (Malvern 2000 instrument). The distribution values are expressed in cumulative volume. Thus, 10% of the particles by volume have a size below the value indicated by Dᵥ10, 50% of the particles by volume have a size below the value indicated by Dᵥ50 and 90% of the particles by volume have a size below the value indicated by Dᵥ90.

According to a preferred embodiment of the invention, the precipitated silica X obtainable by the method of the invention has the following characteristics:
average particle size Dᵥ50≦4 μm,
moisture level≦4 wt. %, and
tap density≦80 g/1

According to an even more preferred embodiment of the invention, the precipitated silica X obtainable by the method of the invention has the following characteristics:
average particle size Dᵥ50≦14 μm,
moisture level≦3 wt. %, and
tap density≦80 g/1

Preferably, the precipitated silica X according to the invention has Dᵥ10<12 μm and even more preferably Dᵥ10<8 μm.

Preferably, the precipitated silica X according to the invention has Dᵥ90<25 μm and even more preferably Dᵥ90<22 μm.

The present invention also relates to a silicone elastomer precursor organopolysiloxane composition comprising the precipitated silica X according to the invention or as obtained by the method according to the invention.

As examples of organopolysiloxane compositions comprising the precipitated silica X, we may mention the compositions for obtaining hot-vulcanized elastomers (HVE) and cold-vulcanized elastomers (CVE), compositions for obtaining LSR (“Liquid Silicone Rubber”), and one-component (such as mastics and cold glues) and two-component RTVs (“Room Temperature Vulcanizing”).

In general, the organopolysiloxane compositions for obtaining HVEs according to the invention comprise (in parts by weight):

a) 100 parts of at least one diorganopolysiloxane rubber (1) having a viscosity above 1 million mPa·s at 25° C.,

b) 0.1 to 7 parts of an organic peroxide (2),

c) 5 to 150 parts of a precipitated silica (3) according to the present invention, and

d) from 0 to 15 parts of at least one diorganopolysiloxane oil (4) with viscosity of at most 5000 mPa·s at 25° C.

The diorganopolysiloxane rubber (1) with viscosity above 1 million mPa·s at 25° C. can for example be a chain of siloxyl units of formula R₂SiO_{2/2}, blocked at each end of its chain by a siloxyl unit of formula R₃SiO_{1/2} and/or a radical of formula OR′; in these formulas, the symbols R, which may be identical or different, represent methyl, ethyl, n-propyl, phenyl, vinyl or trifluoro-3,3,3-propyl radicals, at least 60% of these radicals being methyl and at most 3% being vinyl, the symbol R′ represents a hydrogen atom, an alkyl radical having from 1 to 4 carbon atoms, or a beta-methoxy-ethyl radical.

The diorganopolysiloxane oil (4) with viscosity of at most 5000 mPa·s at 25° C. can be formed from a chain of siloxyl units of formula R″₂SiO_{2/2} blocked at each end of its chain by a radical of formula OR′; in these formulas the symbols R″, which may be identical or different, represent methyl, phenyl or vinyl radicals, at least 40% of these radicals being methyl and the symbol R′ has the meaning given above.

As concrete examples of siloxyl units of formulas R₂SiO_{2/2} and R₃SiO_{1/2} and radicals of formula OR′, we may mention those of formulas:

(CH₃)₂SiO_{2/2}, CH₃(CH₂═CH) SiO_{2/2}, CH₃(C₆H₅) SiO_{2/2}, (C₆H₅)₂SiO_{2/2}, CH₃ (C₂H₅) SiO_{2/2}, (CH₃CH₂CH₂)CH₃SiO_{2/2}, CH₃(n.C₃H₇) SiO_{2/2}, (CH₃)(C₆H₅)(CH₂═CH) Si_{1/2}, —OH, —OCH₃, —OC₂H₅, —O-n.C₃H₇, —O-iso.C₃H₇, —O-n.C₄H_{g}, —OCH₂CH₂OCH₃.

The diorganopolysiloxane oil (4) can be present at a rate from 0 to 15 parts, preferably from 0.3 to 12 parts per 100 parts of rubber (1). This oil or these oils are linear polymers of relatively low viscosity, at most 5000 mPa·s at 25° C., preferably at most 4000 mPa·s at 25° C., whose diorganopolysiloxane chain is formed essentially from the units of the aforementioned formula R″₂SiO_{2/2}; this chain is blocked at each end by a radical of the aforementioned formula OR′. At least 40% of the radicals R″ are methyl radicals, preferably at least 45%. The meaning of the symbols R″ and R′ is explained above.

Preferably, the following are used:
dimethylpolysiloxane oils blocked at each end of their chain by hydroxyl, methoxy or betamethoxyethoxy radicals, with viscosity between 10 and 200 mPa·s at 25° C.;
methylphenylpolysiloxane oils, consisting of CH₃(C₆H₅)SiO_{2/2} units, blocked at each end of their chain by hydroxyl and/or methoxy radicals, with viscosity from 40 to 2000 mPa·s at 25° C.

The organic peroxides (2) are used at a rate of 0.1 to 7 parts, preferably 0.2 to 5 parts, per 100 parts of rubber (1). They are well known by persons skilled in the art and more especially comprise benzoyl peroxide, dichloro-2,4-benzoyl peroxide, dicumyl peroxide, dimethyl-2,5-bis(tert-butylperoxy)-2,5-hexane, t-butyl perbenzoate, peroxy-t-butyl and isopropyl carbonate, di-t-butyl peroxide, bis(t-butylperoxy)-1,1-trimethyl-3,3,5-cyclohexane. These various peroxides decompose at temperatures and at rates that are sometimes different. They are selected and the amount thereof is adjusted in relation to the desired conditions.

The present invention further relates to a silicone elastomer comprising the precipitated silica X according to the invention or such as obtained by the method according to the invention.

The invention finally relates to the use of the precipitated silica X according to the invention or such as obtained by the method according to the invention in tires, toothpastes, cosmetic compositions, foodstuff compositions, pharmaceutical compositions, silicone compositions and elastomers.

In fact, as well as their applications as fillers in silicone-based matrices, the precipitated silicas of the present invention can also be used advantageously as reinforcing filler in matrices based on organic polymers, and in particular in matrices based on one or more elastomers, natural or synthetic, and notably in matrices based on rubber, and more particularly based on natural or synthetic rubbers, of the SBR type or butyl rubber in particular. In fact, the silicas obtained according to the method of the invention have good characteristics of dispersibility and of reinforcement in polymer and elastomer matrices, where they notably allow resistance to abrasion to be increased, which may be advantageous in the context of tire manufacture.

The precipitated silicas of the present invention can also be used advantageously as thickeners in organic or aqueous media, preferably in aqueous media, and notably in toothpastes.

Moreover, the silicas obtained according to the invention may prove useful in many other usual fields of application of precipitated silicas, for example in the manufacture of paints or paper. They have been found to be particularly interesting as supports in food or cosmetic compositions.

The silicas obtained according to the method of the present invention are moreover silicas that are particularly suitable in the pharmaceutical field. Thus, the silicas of the present invention are particularly suitable as fillers, carriers and/or excipients in pharmaceutical compositions.

The aim and the advantages of the present invention will be even clearer from the various non-limiting examples presented below.

### EXAMPLES

Table 1 below describes the commercial silicas used for obtaining the silicas according to the invention.

TABLE 1
Characteristics of the commercial
silicas

| | Silica 1 | Silica 2 | Silica 3 |
|---|---|---|---|
| Supplier | PPG | PPG | MADHU |
| Reference | DXR-190 | DXR-193 | MFIL-P(U) |
| Grinding | Not ground | Not ground | Not ground |
| Dv * 10 (μm) | 26.5 | 30 | 13 |
| Dv * 50 (μm) | 570 | 500 | 77 |
| Dv * 90 (μm) | 1332 | 1300 | 252 |
| Tap density | 285 | 280 | 246 |
| (g/l) | | | |
| Apparent | 253 | 250 | 220 |
| density (g/l) | | | |
| BET (m²/g) | 170 | Not available | 173 |
| CTAB (m²/g) | 171 | Not available | 155 |
| Water content | 5.8 | 5.8 | 5.2 |
| (wt. %) | | | |
| pH | 7.5 | 5.8 | 6.9 |
| Sulfate level | 0.45 | 0.65 | 1 |
| (wt. %) | | | |

Dᵥ distribution of particles by volume for all the examples

The commercial silicas 1, 2 and 3, not ground, are then:
either ground and dried simultaneously according to the invention in an ACM grinding mill from Hosokawa supplied with hot air at 70° C. and equipped with a particle classifier enabling the silicas according to the invention to be recovered (silicas S1, S2 and S3).
or ground conventionally in standard grinding mills (grinding only) to provide us with the comparative examples C1, C2 and C3.

The results are presented in Table 2 below.

TABLE 2
Characteristics of ground silicas (comparative) and silicas ground and
dried simultaneously (invention)

| | Silica | | Silica | | Silica | |
|---|---|---|---|---|---|---|
| | S1 | Comparative | S2 | Comparative | S3 | Comparative |
| | Invention | C1 | Invention | C2 | Invention | C3 |
| Original | Silica 1 | Silica 1 | Silica 2 | Silica 2 | Silica 3 | Silica 3 |
| silica | | | | | | |
| Reference | DXR-190 | DXR-190 | DXR-193 | DXR-193 | MFIL- | MFIL-SR |
| | | | | | P(U) | |
| Grinding | ACM, | Ground | ACM, | Ground | ACM, | Ground |
| | 70° C. | PPG | 70° C. | PPG | 70° C. | Madhu |
| Dv10 (μm) | 4.1 | 12.5 | 7.4 | 14.2 | 4.3 | 4.8 |
| Dv50 (μm) | 9.1 | 51 | 12.3 | 34 | 9.7 | 11 |
| Dv90 (μm) | 18 | 128 | 20 | 68 | 20 | 27 |
| Tap density | 54 | 184 | 74 | 153 | 51 | 86 |
| (g/l) | | | | | | |
| Water content | 4 | 5.8 | 4.7 | 5.8 | 4.1 | 5.2 |
| (wt. %) | | | | | | |

Simultaneous grinding-drying of the various commercial precipitated silicas gives repeatable quality of precipitated silica even starting from silicas of different grades. The average particle size Dᵥ50 is between 9 and 12.5 micrometers and the moisture level is below 5 wt. %.

The silicas ground and dried simultaneously, obtained by the method according to the invention (silicas S1 to S3), as well as those ground conventionally, i.e. without simultaneous drying (comparative silicas C1 to C3), were used as reinforcing fillers in two hot-vulcanizable silicone compositions.

Silicone Composition A (all Parts Given are by Weight)

The compounds shown in Table 3 below are put in a Z-arm kneader mixer. They are mixed for 30 minutes. Then the temperature of the mixer is raised to 150° C. in one hour, and is then maintained at 150° C. for one hour. Then heating is switched off and mixing continues for one hour. The mixer is lightly purged with nitrogen throughout.

TABLE 3
Formulation of silicone composition A (parts
by weight)

| Composition A | parts |
|---|---|
| Polyorganosiloxane rubber with about | 97.96 |
| 0.05 wt. % of Vi groups^{(a)} at the chain ends | |
| and in the chain and having a viscosity of 20 | |
| million mPa · s at 25° C. | |
| Polyorganosiloxane rubber with about 2.3 wt. % | 2.04 |
| of Vi groups in the chain and having a | |
| viscosity of 20 million mPa · s at 25° C. | |
| Oil hydroxylated at the chain ends with about | 4.6 |
| 8.5 wt. % of OH groups and having a viscosity | |
| of 50 of mPa · s at 25° C. | |
| Precipitated silica | 41.9 |
| 3-Trimethoxysilylpropyl methacrylate | 0.10 |
| Thermal stability additive based on Iron 3+ | 0.65 |
| complex | |
| Calcium carbonate | 0.17 |

^{(a)}Vi denotes vinyl for all the examples

The composition thus obtained is put in a twin-roller mixer and 1.25 parts of dichloro-2,4-benzoyl peroxide diluted to 50 wt. % in a silicone oil is added as catalyst. A fraction of the homogeneous mass obtained in the mixer is used for measuring the mechanical properties of the silicone elastomer resulting from hot vulcanization of the polyorganosiloxane composition. For this purpose, the fraction of homogeneous mass taken is then press-vulcanized for 8 minutes at 115° C. using a suitable mold for obtaining plates with a thickness of 2 mm. Plates are thus obtained in the unannealed (UA) state. These plates are then subjected to annealing or aging for 4 hours at 200° C. Standardized samples are then taken from all of these plates and the following properties are measured:
Shore Hardness A (SHA) according to AFNOR standard NFT 46-004
Breaking strength (BS) in MPa according to AFNOR standard NFT 46-002
Elongation at break (EB) in % according to AFNOR standard NFT 46-002
Elastic modulus (EM) at 100% in MPa according to ASTM standard D412
Tearing strength (TS) in kN/m according to ASTM standard D624-73
Residual compression strain (RCS) in % according to ASTM standard D395-03, method B (25%, 177° C., 22 hours)

The following Table 4 shows the mechanical properties of the silicone elastomers obtained using the silicas ground and dried simultaneously by the method according to the invention (Examples A1 to A3 with silicas S1 to S3) and the silicas ground conventionally, i.e. without simultaneous drying (comparative examples AC1 to AC3 with silicas C1 to C3).

TABLE 4
Mechanical properties of the elastomers
obtained from the silicone compositions A

| | SHA | BS | EB | EM 100% | TS | RCS |
|---|---|---|---|---|---|---|
| | Shore A | MPa | % | MPa | kN/m | % |
| Example A1 | 55 | 8.4 | 317 | 2.2 | 11 | 39 |
| Silica S1 | | | | | | |
| Invention | | | | | | |
| Comparative AC1 | 57 | 7.4 | 277 | 2.3 | 11 | 50 |
| Silica C1 | | | | | | |
| Example A2 | 57 | 9.9 | 318 | 2.4 | 11 | 24 |
| Silica S2 | | | | | | |
| Invention | | | | | | |
| Comparative AC2 | 56 | 6.8 | 241 | 2.5 | 10 | 31 |
| Silica C2 | | | | | | |
| Example A3 | 57 | 9.0 | 342 | 2.2 | 11 | 14 |
| Silica S3 | | | | | | |
| Invention | | | | | | |
| Comparative AC3 | 58 | 5.3 | 229 | 2.4 | 11 | 16 |
| Silica C3 | | | | | | |

These results show that the elastomers formulated with the silicas ground and dried simultaneously according to the method of the invention (Examples A1, A2 and A3) have much higher breaking strength (BS) and elongation at break (EB) than for the silicas ground conventionally, i.e. without simultaneous drying (comparative examples AC1, AC2 and AC3).

Silicone Composition B (all Parts Given are by Weight)

The compounds shown in Table 5 below are put in a Z-arm kneader mixer. They are mixed for 30 minutes. Then the temperature of the mixer is raised to 150° C. in one hour, and is then maintained at 150° C. for one hour. Then heating is switched off and mixing continues for one hour. The mixer is lightly purged with nitrogen throughout.

TABLE 5
Formulation of silicone composition B (parts
by weight)

| Composition B | parts |
|---|---|
| Polyorganopolysiloxane rubber with about | 75.05 |
| 0.012 wt. % of Vi groups at the chain ends | |
| and having a viscosity of 20 million mPa · s | |
| at 25° C. | |
| Polyorganopolysiloxane rubber with about | 19.98 |
| 0.076 wt. % of Vi groups in the chain and | |
| having a viscosity of 20 million mPa · s at | |
| 25° C. | |
| Polyorganosiloxane rubber with about | 4.97 |
| 2.3 wt. % of Vi groups in the chain and | |
| having a viscosity of 500 000 mPa · s at | |
| 25° C. | |
| Oil hydroxylated at the chain ends with | 5.52 |
| about 8.5 wt. % of OH groups and having a | |
| viscosity of 50 mPa · s at 25° C. | |
| Oil methoxylated at the chain ends with | 2.01 |
| about 9 wt. % of SiOMe and partially | |
| phenylated (Phi2) in the chain | |
| Precipitated silica | 48.78 |
| 3-Trimethoxysilylpropyl methacrylate | 0.71 |
| Calcium carbonate | 0.17 |

The composition thus obtained is put in a twin-roller mixer and 0.6 parts of dimethyl-2,5-bis(tert-butylperoxy)-2,5-hexane diluted to 75 wt. % in a silicone oil is added as catalyst. A fraction of the homogeneous mass obtained in the mixer is used for measuring the mechanical properties of the silicone elastomer resulting from hot vulcanization of the polyorganosiloxane composition. For this purpose, the fraction of homogeneous mass taken is then press-vulcanized for 10 minutes at 170° C. using a suitable mold for obtaining plates with a thickness of 2 mm. Plates are thus obtained in the unannealed (UA) state. These plates are then subjected to annealing or aging for 4 hours at 200° C. Standardized samples are then taken from all of these plates and the same properties are measured as for silicone composition A.

The following Table 6 shows the mechanical properties of the silicone elastomers obtained using the silicas ground and dried simultaneously by the method according to the invention (Examples B1 to B3 with silicas S1 to S3) and those ground conventionally, i.e. without simultaneous drying (comparative examples BC1 to BC3 with silicas C1 to C3).

TABLE 6
Mechanical properties of the elastomers
obtained from silicone compositions B

| | SHA | BS | EB | EM 100% | TS | RCS |
|---|---|---|---|---|---|---|
| | Shore A | MPa | % | MPa | kN/m | % |
| Example B1 | 69 | 8.1 | 366 | 2.6 | 17 | 13 |
| Silica S1 | | | | | | |
| Invention | | | | | | |
| Comparative BC1 | 69 | 6.8 | 337 | 2.4 | 17 | 11 |
| Silica C1 | | | | | | |
| Example B2 | 72 | 8.3 | 382 | 2.6 | 18 | 13 |
| Silica S2 | | | | | | |
| Invention | | | | | | |
| Comparative BC2 | 72 | 6.8 | 282 | 2.8 | 17 | 11 |
| Silica C2 | | | | | | |
| Example B3 | 65 | 8.3 | 394 | 2.4 | 15 | 9 |
| Silica S3 | | | | | | |
| Invention | | | | | | |
| Comparative BC3 | 66 | 5.6 | 288 | 2.3 | 15 | 9 |
| Silica C3 | | | | | | |

These results show that the elastomers formulated with the silicas ground and dried according to the invention (Examples B1, B2 and B3) have much higher breaking strength (BS), elongation at break (EB) and residual compression strain (RCS) than for the silicas ground by the suppliers (comparative examples BC1, BC2 and BC3).

1. A method for preparing a precipitated silica that is dispersible and has improved reinforcing properties comprising:
a) reacting at least one silicate with at least one acidifying agent, so as to obtain a suspension of precipitated silica,
b) filtering and washing said suspension of precipitated silica, so as to obtain a filter cake,
c) drying said filter cake to obtain powder of precipitated silica, and
d) grinding and drying said precipitated silica, which are carried out simultaneously in a mechanical grinding mill and at a temperature from 50 to 190° C., optionally from 60 to 150° C., and recovering said precipitated silica.

2. The method as claimed in claim 1, wherein in d), temperature in said mechanical grinding mill is controlled by supplying air heated to a temperature from 50 to 190° C., optionally from 60 to 150°.

3. The method as claimed in claim 1, wherein d) is carried out by said mechanical grinding mill by attrition.

4. The method as claimed in claim 1, wherein d) is carried out by mechanical grinding mill by attrition in a grinding chamber equipped with a rotor and a stator.

5. The method as claimed in claim 1, wherein in d), the mechanical grinding mill is equipped with an integrated particle classifier for recovering the particles of precipitated silica.

6. The method as claimed in claim 1, wherein in d), the mechanical grinding mill is linked to an independent particle classifier for recovering the particles of precipitated silica.

7. The method as claimed in claim 1, wherein d) takes place under atmospheric pressure.

8. The method as claimed in claim 1, wherein in c), said precipitated silica has the following characteristics:
a BET surface area from 50 to 300 m²/g,
a CTAB surface area from 50 to 300 m²/g,
the value BET-CTAB<50 m²/g,
a moisture level from 4 to 10 wt. %,
a pH from 4 to 8,
a level of sulfates SO₄⁻<1.5 wt. %, and
a tap density≧100 g/1.

9. A precipitated silica obtainable by the method of claim 1, wherein said precipitated silica has the following characteristics:
average particle size Dᵥ50≦20 micrometers,
moisture level≦5 wt. %, and
tap density≦100 g/l.

10. A silicone elastomer precursor organopolysiloxane composition comprising said precipitated silica as claimed in claim 9.

11. A silicone elastomer comprising said precipitated silica as claimed in claim 9.

12. The precipitated silica as claimed in claim 9, capable of being used in one or more tires, toothpastes, cosmetic compositions, foodstuff compositions, pharmaceutical compositions, silicone compositions and/or elastomers.

13. A silicone elastomer precursor organopolysiloxane composition comprising precipitated silica obtainable according to a method of claim 1.

14. A silicone elastomer comprising precipitated silica obtainable according to a method of claim 1.

15. The precipitated silica obtainable according to a method of claim 1, and being capable of being used in one or more tires, toothpastes, cosmetic compositions, foodstuff compositions, pharmaceutical compositions, silicone compositions and/or elastomers.
